(19) United States
(12) Patent Application Publication
(10) Pub. No.: US 2004/0141541 A1
(43) Pub. Date: Jul. 22, 2004

(54) MEMS-based thermogravimetric analyzer

(76) Inventors: John Williams, Lexington, MA (US); Megan Owens, Somerville, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/723,332

(22) Filed: Nov. 26, 2003

Related U.S. Application Data
(60) Provisional application No. 60/430,283, filed on Dec. 2, 2002.

(51) Int. Cl. G01N 25/00

(52) U.S. Cl. 374/14

(57) ABSTRACT

A TGA based on a microelectromechanical system (MEMS) architecture and employing a flexural plate wave (FPW) mass sensor provides substantially improved mass sensitivity at a significantly reduced cost in comparison to traditional TGAs. The output of an FPW reference sensor is monitored to determine and compensate for any thermally-induced output of the FPW mass sensor.

### CROSS-REFERENCE TO RELATED APPLICATION

This application claims priority to and the benefit of, and incorporates herein by reference in its entirety, provisional U.S. patent application No. 60/430,283, filed Dec. 2, 2002.

### TECHNICAL FIELD

The present invention generally relates to apparatus and methods for thermogravimetric analysis, and more particularly to a MEMS-based thermogravimetric analyzer.

### BACKGROUND

A thermogravimetric analyzer (TGA) is a device used to detect changes in a sample's mass either in response to controlled variations in temperature or as a function of time over which a sample is maintained at an isothermal level. This functionality allows a user to, among other things, determine the composition of multicomponent systems, measure the thermal stability of materials, measure the oxidative stability of materials, estimate the lifetime of a product, analyze the decomposition kinetics of materials, analyze the effect of reactive or corrosive atmospheres on materials, ascertain the moisture content and volatiles content of materials, learn transition temperatures of materials, and ascertain melting and boiling points. TGAs can further be used for theoretical research on new materials and processes including material selection, formulation optimization, applications development, end-use performance prediction, competitive product evaluation, and quality control.

Traditional TGAs typically involve sensitive mechanical balances, furnaces, various apparatus to supply the furnace with desired gasses, and computer-based control and analysis equipment. Based on these designs, TGAs able to detect changes in mass on the order of 200-1000 nanograms have been built. Such TGA hardware is quite expensive and can be difficult or cumbersome to operate.

### SUMMARY OF THE INVENTION

A TGA based on a microelectromechanical system (MEMS) architecture and employing a flexural plate wave (FPW) mass sensor provides substantially improved mass sensitivity at a significantly reduced cost in comparison to traditional TGAs. FPW mass sensors have been shown to achieve mass detection sensitivities on the order of 0.5 nanogram. FPWs, however, suffer from heat sensitivity as well, making them difficult to incorporate into devices that require operation over large, and potentially rapidly varying, temperature ranges. The FPW-based analyzer of the present invention, however, allows a user to take advantage of the enhanced mass-sensing capabilities of an FPW mass sensor in such an inhospitable thermal environment by determining and compensating for thermally-induced variations in FPW output.

In one aspect, the invention relates to a TGA that includes an FPW mass sensor and an FPW reference sensor. The FPW mass sensor has a sample-holding region. In one embodiment, the TGA has multiple FPW mass sensors. The TGA can also have multiple FPW reference sensors, wherein each reference sensor corresponds to one of the FPW mass sensors. The TGA also includes a heat spreader to conduct heat substantially evenly to both the mass sensor and the reference sensor. The TGA includes a heater to heat the sensors via the heat spreader. In one embodiment, the heater is a variable-output, controllable heater. The TGA further includes an analysis module in electrical communication with the sensors. The analysis module, based on the outputs of the sensors, determines a change in mass of a sample in the sample-holding region caused by action of the heater.

In one embodiment, the TGA also includes a control module in electrical communication with the heater for varying the heat output of the heater in accordance with an analytical protocol. For example, in one embodiment, the analytical protocol may include heating a sample according to a predetermined time-temperature pattern. The heater can also be controlled manually by a user.

In a further embodiment, the TGA includes a temperature sensor in thermal communication with each FPW and the analysis module. In such embodiments, the analysis module determines a change in mass of a sample in relation to the outputs of the temperature sensors and the FPWs.

In another aspect, the invention relates to a method of conducting thermogravimetric analysis. The method includes providing an FPW mass sensor configured to output a mass signal, and depositing a sample in the sensor. The method further includes providing an FPW reference sensor for outputting a reference signal. The sensors are heated evenly and changes in mass are determined in response to the heating based on the mass and reference signals. In one embodiment, the determination of mass changes includes measuring the mass and reference signals and taking the difference of the two. A mass change is then determined based on the determined signal difference. In one embodiment, the method also includes monitoring the temperatures of the FPW sensors.

Based on the determined mass changes and detected temperatures, in one embodiment the method includes determining a heat-mass response characterization of the sample. In another embodiment, the method includes determining a heat-mass-time response characterization of a sample based on the determined mass changes, the monitored temperatures, and the time at which the sample was maintained at the monitored temperatures. The heating of the FPWs and the sample can be controlled in accordance with an analysis protocol, in accordance with a pre-determined time-temperature pattern, or manually by a user.

### BRIEF DESCRIPTION OF THE DRAWINGS

The foregoing discussion will be understood more readily from the following detailed description of the invention, when taken in conjunction with the accompanying drawings, in which:

FIG. 1 is a schematic diagram of a MEMS-based thermogravimetric analyzer according to one embodiment of the invention.

FIG. 2 is a flow chart of a method of conducting thermogravimetric analysis according to one embodiment of the invention.

### DETAILED DESCRIPTION

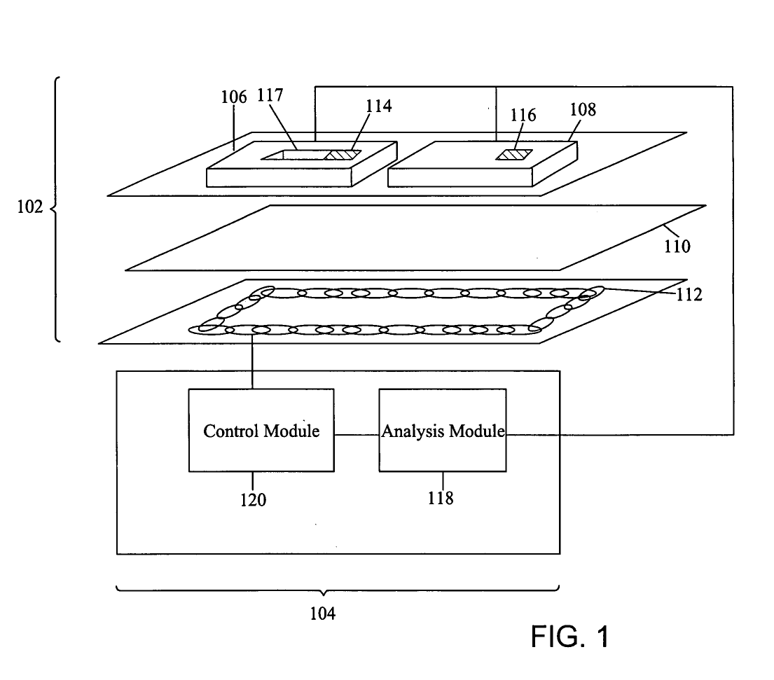

FIG. 1 is a schematic diagram of a MEMS-based thermogravimetric analyzer (MTGA) 100 according to one embodiment of the invention. The MTGA 100, in general, can conceptually be divided into two portions, a sensor portion 102 and a control and analysis portion 104.

The sensor portion 102 of the MTGA 100, in the illustrative embodiment, includes a flexural plate wave (“FPW”) mass sensor 106, an FPW reference sensor 108, a heat spreader 110, and a heater 112. Each FPW sensor 106 and 108 also has a corresponding temperature sensor 114 and 116.

The mass sensing capabilities of the MTGA 100 are provided by the FPW mass sensor 106 and the FPW reference sensor 108. Suitable FPW sensors, as described, for example, in U.S. Pat. No. 5,212,988 (the entire disclosure of which is hereby incorporated by reference), are known in the art to provide the ability to measure mass with a sensitivity in the order 0.5 nanogram. In general, an FPW initiates a Lamb wave with a given frequency, e.g., 18 MHz, at one end of a propagation medium and detects the frequency of the Lamb wave at the other end of the propagation medium (the “detected frequency”). Applying a mass load to the propagation medium will result in a variation in the detected frequency. For example, in one embodiment, a frequency change of 50 Hz corresponds to a 1 nanogram change in the mass load of the propagation medium.

FPW sensors, however, are also highly sensitive to temperature. That is, just as changing the mass load applied to the propagation medium results in a change in the detected frequency, changing the temperature of the propagation medium also results in a change to the detected frequency. To compensate for the temperature sensitivity of an FPW sensor, the illustrative embodiment of the MTGA includes both an FPW mass sensor 106 and an FPW reference sensor 108. The FPW mass sensor 106 includes a sample-holding region 117 for deposition of a sample. The sample can be deposited in a solid or liquid phase. The FPW reference sensor 108 ordinarily does not include a sample-holding region 117. Since both FPW sensors 106, 108 are heated isothermally, as described in further detail below, changes in the detected frequencies of the sensors 106, 108 can be compared to determine the portion of any frequency change attributable to a change in mass, as opposed to a change in temperature. In the illustrative embodiment, each FPW 106, 108 has a corresponding temperature sensor 114, 116. The temperature sensors 114, 116 can be standard temperature transducers that convert a sensed temperature into an electrical signal (or a measurable change in an electrical property, such as resistance) or any other form of temperature sensor known in the art.

In one embodiment, the MTGA includes an array of FPW mass sensors 106. Such an embodiment can include a single FPW reference sensor 108, or it can include an FPW reference sensor 108 for each FPW mass sensor 106. An MTGA 100 that includes an array of FPW mass sensors 108 provides a high throughput sensing capability by allowing multiple samples to be analyzed simultaneously.

In one embodiment, the FPW sensors 106, 108 and the temperature sensors 114, 116 (collectively, the sensors) are coupled to a ceramic (e.g., aluminum oxide) substrate or printed circuit board. In another embodiment, the printed circuit board may be made of an epoxy resin, such as a FR-4 epoxy-glass circuit board. The sensors 106, 108, 114, 116 are coupled to the substrate or printed circuit board using, for example, epoxy, silver-glass-paste adhesives, eutectic bonds or an amalgam. The FPW sensors 106 and 108 and the temperature sensors 114 and 116 are connected electrically to the printed circuit board, in one embodiment, with gold-gold bonds. The electrical connections to the FPW sensors 106, 108 supply drive signals to the FPW for initiating the Lamb wave and receive an electrical signal corresponding to the detected frequency. The electrical connections to the temperature sensors 114, 116 receive signals corresponding to the temperature of the FPW sensors 106, 108.

The printed circuit board is further coupled to the heat spreader 110. In one embodiment, the printed circuit board is mechanically and thermally coupled to the heat spreader 110 using a high-strength film, such as the ABLEFILM 550 adhesive, available from Emerson and Cuming of Billerica, Mass. Of course, any technique known in the art capable of withstanding both high temperatures and large temperature changes can be used. The heat spreader 110 comprises or is composed of a heat conductive material, such as copper.

In the illustrated embodiment, the heat spreader 110 is further coupled to the heater 112. The heater 110 includes resistive elements, such as copper wiring through which current is driven, generating heat. In the illustrative embodiment, the resistive elements are deposited upon a substrate (e.g., a polymide film substrate, such as the KAPTON polymide film substrate available from E. I. du Pont de Nemours and Company), spaced in a pattern evenly across the substrate's surface. As the heater 112 radiates heat, the heat spreader 110 receives the heat energy and further distributes it across its surface. As a result, both the FPW mass sensor 106 and the FPW reference sensor 108 receive substantially the same amount of heat, and their temperatures change substantially isothermally.

In one embodiment, the FPW sensors 106, 108, heat spreader 110, heater 112, and temperature sensors 114 and 116 are disposed in a carrier, which can have a removable cover. In one embodiment, the carrier is built out of a gold covered metal alloy, preferably a KOVAR alloy available from ASPE, Inc., Airfield, N.J. In general, other compounds and materials can be used to construct the carrier, heater, heat spreader, and printed circuit board, but these should be capable of withstanding large temperature shifts and should share a substantially similar rate of thermal expansion.

The sensor portion 102 of the MTGA 100 is in electrical communication with the control and analysis portion 104 of the MTGA 100. In one embodiment, the two portions 102, 104 can be combined into a single chassis as a stand-alone piece of equipment. For example, the carrier can be included in a chassis including a special purpose computer with a user interface and display screen. The carrier can be removable from the chassis, or it can be fixed. In another embodiment, the control and analysis portion of the MTGA 104 is physically separate from the carrier 102. For example, the control and analysis portion 104 can be implemented as software operating on a general purpose or special purpose computer, in electrical communication with the sensor portion 102. Alternatively, the control and analysis portion can be implemented in firmware or hardware.

The control and analysis portion 104 of the MTGA 100 includes an analysis module 118, a control module 120, and a user interface (not shown). The analysis module 118 is in electrical communication with the sensor portion 102 of the MTGA 100. The communication can be through a direct electrical connection, over a network, or via a wireless connection. The analysis module 118 receives output from the sensors 106, 108, 114, 116, or a signal that corresponds to the output of the sensors (e.g., a digital representation of the outputs). Based on the sensor signals, the analysis module 118 determines the mass change of a sample by first subtracting the output of the FPW reference sensor 106 from the output of the FPW mass sensor 104. The difference between the signals corresponds to the change in mass, which may be readily ascertained given a known relationship between detected frequency and sample mass. The analysis module also correlates mass change with the outputs of the temperature sensors 114, 116 and time. In one embodiment, the analysis module stores mass change data and temperature data on a storage device, for example, an optical or magnetic disk drive. The analysis module carries out (e.g., pursuant to stored software instructions) a variety of thermogravimetric analytical protocols, including, without limitation, composition analysis of multi-component systems, measurement of the thermal stability of materials, measurement of the oxidative stability of materials, estimation of the lifetime of a product, determination of the decomposition kinetics of materials, analysis of the effect of reactive or corrosive atmospheres on materials, ascertainment of the moisture content and volatiles content of materials, determination of the transition temperatures of materials, and ascertainment of melting and boiling points, all of which are known in the art. In one embodiment, the results of the analytical functions, for example in the form of temperature-mass graphs or time-temperature-mass graphs, are output to a display screen.

In one embodiment, the analysis module is also in communication with the control module 120. The control module 120 communicates with the heater 112 of the MTGA 100 to control the heating of the FPW sensors 106, 108. The control module 120 directs current through the heater 112 at varying levels. The analysis module 118 can direct the control module 120 to heat the sensor portion 102 in accordance with the thermogravimetric analysis protocols and/or a predetermined time-temperature pattern. Alternatively, a user of the MTGA 100 can manually direct and vary the degree and duration of heating through the use of the user interface.

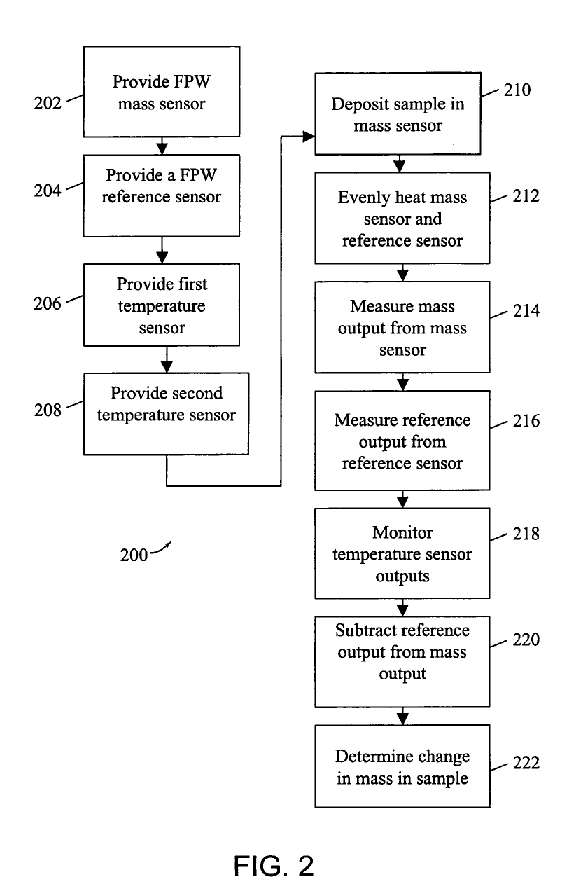

FIG. 2 is a flow chart of a method 200 of conducting thermogravimetric analysis according to one embodiment of the invention. The method includes providing an FPW mass sensor (e.g., 106) (step 202), providing an FPW reference sensor (e.g., 108) (step 204), providing a first temperature sensor (e.g., 114) that corresponds to the FPW mass sensor (step 206), and providing a second temperature sensor (e.g., 116) that corresponds to the FPW reference sensor (step 208).

A sample is deposited in sample-holding region 117 of the FPW mass sensor 106 (step 210). The FPW mass sensor 106, the sample, and the FPW reference sensor 108 are heated substantially isothermally (step 212). In one embodiment, the sensors 106, 108, 114, 116 and the sample are heated in accordance with a thermogravimetric analysis protocol. For example, the sample can be heated until its mass begins to change. The temperature can then be kept constant until the mass of the sample stops changing, at which point heating can be continued until a further mass change is detected. Such a heating pattern can be used to determine the proportional composition of a multi-component system as various components reach either their boiling or combustion points.

In another embodiment, the sensors 106, 108, 114, and 116 and the sample are heated in accordance with a pre-determined time-temperature pattern. For example, the sensors 106, 108, 114, and 116 and sample can be heated to a series of predetermined temperatures. The mass of the sample can be monitored over a predetermined period of time at each temperature to measure the heat stability of the sample. In another embodiment, the heating can be controlled manually by a user.

As the sample and the sensors 106, 108, 114, 116 are being heated, the outputs of the FPW mass sensor 106 and the FPW reference sensor 108 are measured (steps 214 and 216, respectively). The temperatures of each of the FPW sensors 106, 108 are also monitored via the temperature sensors 114, 116 (step 218). The outputs of the FPW sensors 106, 108 are compared, and any frequency changes detected in the output of the FPW reference sensor 108 are subtracted from the frequency changes detected in the FPW mass sensor 106 (step 220). The resultant detected frequency change is used to determine a mass change in the sample (step 222). For example, in one embodiment, a frequency change of 50 Hz corresponds to a mass change of 1 nanogram. The mass of the sample and the monitored temperatures are correlated to an elapsed time so that further analysis of the sample can be carried out (e.g., determining a heat-mass characterization, or a heat-mass-time characterization of the sample).

One skilled in the art will realize the invention may be embodied in other specific forms without departing from the spirit or essential characteristics thereof. The foregoing embodiments are therefore to be considered in all respects illustrative rather than limiting of the invention. The scope of the invention is not limited to just the foregoing description.

What is claimed is:

1. A thermogravimetric analyzer comprising:
a flexural plate wave mass sensor comprising a sample-holding region;
a flexural plate wave reference sensor;
a heat spreader configured to conduct heat substantially evenly to the mass sensor and the reference sensor;
a heater in thermal communication with the heat spreader;
an analysis module, in electrical communication with the mass sensor and the reference sensor, for determining, based on outputs of the mass sensor and the reference sensor, a change in mass of a sample in the sample-holding region caused by action of the heater.

2. The thermogravimetric analyzer of claim 1 wherein the heater is a variable-output, controllable heater.

3. The thermogravimetric analyzer of claim 2 further comprising:
a control module in electrical communication with the heater for varying the heat output of the heater in accordance with an analytical protocol.

4. The thermogravimetric analyzer of claim 3 wherein the control module causes the heater to heat the sample in accordance with a pre-determined time-temperature pattern.

5. The thermogravimetric analyzer of claim 1 further comprising:
a temperature sensor in thermal communication with the mass sensor; and
a temperature sensor in thermal communication with the reference sensor, the analysis module analyzing the determined change in mass in relation to the outputs of the temperature sensors.

6. The thermogravimetric analyzer of claim 1 further comprising a plurality of flexural plate wave mass sensors arranged in an array.

7. The thermogravimetric analyzer of claim 6 further comprising a plurality of flexural plate wave reference sensors, each flexural plate wave sensor corresponding to and outputting a reference signal for one of the arrayed plurality flexural plate wave mass sensors.

8. A method of conducting thermogravimetric analysis comprising:
providing a flexural plate wave mass sensor configured to output a mass signal;
depositing a sample in the mass sensor;
providing a flexural plate wave reference sensor configured to output a reference signal;
evenly heating the mass sensor and the reference sensor; and
determining a change in mass of the sample in response to the heating based on the mass signal and the reference signal.

9. The method of claim 8 further comprising:
measuring a mass output from the mass sensor;
measuring a reference output from the reference sensor; and
subtracting the reference output from the mass output.

10. The method of claim 8 further comprising monitoring the temperatures of the mass sensor and the reference sensor as the sample is heated.

11. The method of claim 10 further comprising determining a heat-mass response characterization of a sample based on the determined mass changes in relation to the monitored temperatures.

12. The method of claim 10 further comprising determining a heat-mass-time response characterization of a sample based on the determined mass changes, the monitored temperatures, and the time at which the sample was maintained at the monitored temperatures.

13. The method of claim 8 wherein the heating is controlled in accordance with an analysis protocol.

14. The method of claim 8 wherein the heating is controlled in accordance with a pre-determined time-temperature pattern.
